(19) United States
(12) Patent Application Publication
(10) Pub. No.: US 2022/0300567 A1
(43) Pub. Date: Sep. 22, 2022

(54) SYSTEMS AND METHODS FOR SOCIAL-CURRENCY-BASED CHART GENERATION

(71) Applicant: Meta Platforms, Inc., Menlo Park, CA (US)

(72) Inventor: Debashish Paul, Sunnyvale, CA (US)

(21) Appl. No.: 16/775,631

(22) Filed: Jan. 29, 2020

(51) Int. Cl. G06F 16/958; G06Q 50/00; G06F 16/957

(52) U.S. Cl. CPC G06F 16/958; G06Q 50/01; G06F 16/9577

(57) ABSTRACT

A computer-implemented method for social-currency-based chart generation may include (i) identifying an item of media hosted on a social networking platform that tracks social currency scores for media, (ii) tracking a social currency score for the item of media that increases whenever a user of the social networking platform performs a social-currency-generation action on the item of media, (iii) defining parameters for items of media to be included in a media popularity chart for the social networking platform, and (iv) ranking the item of media in the media popularity chart in accordance with the social currency score for the item of media relative to social currency scores for other items of media and based on the item of media fitting the parameters for inclusion in the media popularity chart. Various other methods, systems, and computer-readable media are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram of an exemplary system for social-currency-based chart generation.

FIG. 2 is a flow diagram of an exemplary method for social-currency-based chart generation.

FIG. 3 is an illustration of an exemplary set of social-currency-generation actions.

FIG. 4 is an illustration of an exemplary social-currency-based chart.

FIG. 5 is an illustration of an exemplary music interface.

FIG. 6 is an illustration of an exemplary user landing page for social-currency-based charts.

FIG. 7 is an illustration of an exemplary group landing page for social-currency-based charts.

FIG. 8 is a block diagram of an exemplary system for social-currency-based chart generation.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

Features from any of the embodiments described herein may be used in combination with one another in accordance with the general principles described herein. These and other embodiments, features, and advantages will be more fully understood upon reading the following detailed description in conjunction with the accompanying drawings and claims.

### DETAILED DESCRIPTION OF EXEMPLARY EMBODIMENTS

Many applications and services exist for streaming and discovering music. Nonetheless, one of the largest drivers of music discovery remains personal recommendation from friends and acquaintances. This makes social networking platforms an ideal place to host music streaming and discovery. Additionally, the ability of a social networking platform to collect and aggregate social data, such as “likes” and “shares” from users, provides a unique opportunity to generate popularity charts for music and other media (such as videos) that are based on actions taken by users.

The present disclosure is generally directed to generating popularity charts for media based on social-currency-generation actions taken by users in relation to this media. For example, a user loving or liking a piece of media may produce a small amount of social currency while a user sharing the piece of media may produce a larger amount of social currency. Multiple different types of social-currency-generation actions with different weightings may be used to determine the chart ranking of a piece of media. In some cases, a dashboard may provide the creator of the media with statistics about the quantity of each type of social-currency-generation action taken on the media by users, giving the creator insight into the relative popularity of different pieces of media across various platforms. In some embodiments, a media service may generate custom social-currency-based charts for individual users, groups, media categories, and/or genres. For example, a media service may generate tailored popularity charts for interest-defined groups, regional groups, social groups, and/or other types of groups. In some examples, the media service may enable users to discover new media via tailored popularity charts for groups.

In addition, a unified media layer may enable a user to interact with a piece of media (e.g., listen to a song), share the media, tag and/or otherwise categorize the media, add the media to a collection, and/or view additional information about the media. In some cases, the unified media layer may include information about a song or video's popularity, a link to the artist's personal page, a list of charts in which the piece of media is trending, and/or other information.

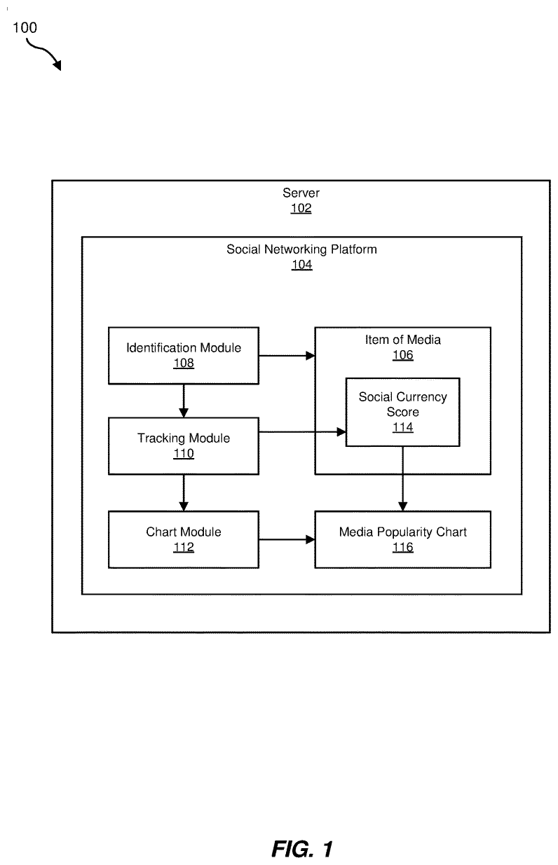

In some embodiments, the systems described herein may be hosted on one or more servers. FIG. 1 is a block diagram of an exemplary system 100 for generating social-currency-based charts on a social networking platform. In one embodiment, and as will be described in greater detail below, a server 102 may be configured with an identification module 108 that may identify an item of media 106 hosted on a social networking platform 104 that tracks social currency scores for media. Although illustrated as a single sever, in some embodiments, server 102 may represent multiple servers in the same or different physical locations (e.g., cloud servers). In some embodiments, a tracking module 110 on server 102 may track a social currency score 114 for item of media 106 that increases whenever a user of social networking platform 104 performs a social-currency-generation action on item of media 106. In one embodiment, a chart module 112 may define parameters for items of media to be included in a media popularity chart 116 for the social networking platform. In some examples, chart module 112 may rank item of media 106 in media popularity chart 116 in accordance with social currency score 114 for item of media 106 relative to social currency scores for other items of media and based on item of media 106 fitting the parameters for inclusion in media popularity chart 116.

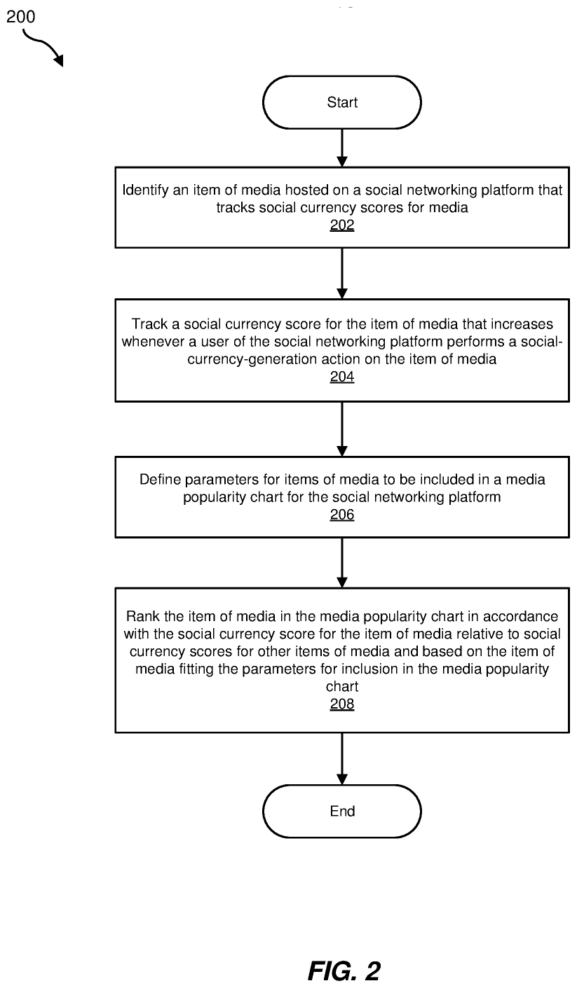

FIG. 2 is a flow diagram of an exemplary method 200 for generating social-currency-based media popularity charts. In some examples, at step 202, one or more of the systems described herein may identify an item of media hosted on a social networking platform that tracks social currency scores for media. For example, identification module 108 may, as part of server 102 in FIG. 1, identify item of media 106 hosted on social networking platform 104 that tracks social currency scores for media.

In some examples, the term “media,” as used herein, may generally refer to any type of image, video, audio, text, animation, and/or combination thereof. In some embodiments, an item of media may be a song or a portion of a song. Additionally or alternatively, an item of media may be a video (or a portion of a video), such as a music video. In some embodiments, an item of media may be embedded in other items of media. For example, a lyric video of a song and a music video of the same song may both count as the same item of media (the song) when tracking social currency scores for the song. In other examples, different variations of a piece of media may count as different items of media for tracking social currency scores.

In some embodiments, the term “social networking platform,” as used herein, may generally refer to any website, web application, and/or combination thereof that enables users to form connections with other users, make public and/or private posts, send messages, and/or share media. In some embodiments, a social networking platform may include interest-base groups of users that can be joined by users who share an interest and/or hobby. In one embodiment, a social networking platform may enable users to upload items of media. Additionally or alternatively, a social networking platform may enable users to reference and/or share items of media hosted elsewhere. In some embodiments, a social networking platform may enable users to perform actions on items of media such as indicating sentiments (e.g., “liking,” “loving,” “crying,” “laughing,” and/or other reactions), sharing media (publicly or privately to a select audience), commenting on media, and/or saving media (e.g., to a private media collection).

In some examples, the term “social currency,” as used herein, may generally refer to any numerical representation of actions performed by users on an item of media. In some embodiments, the systems described herein may track a social currency score for each item of media hosted on and/or linked to by the social networking platform. Alternatively, the systems described herein may track a social currency score for select categories of media items (e.g., only music and videos). In some embodiments, the systems described herein may track aggregated social media scores for creators of media items. In one embodiment, each action a user performs on an item of media may increase the social currency for the item of media. In some embodiments, only certain categories of actions may contribute to social currency. For example, playing a song may not generate social currency but sharing the song may generate social currency. In some embodiments, a social currency score may be represented as an integer. Additionally or alternatively, a social currency score may be tracked and/or stored as a set of numerical representations of social currency accrued from different sources. For example, a social currency score may include a sentiment-based score, a shares-based score, and/or a saves-based score. In some examples, a “social-currency-generation action” may represent any action performed by a user that impacts a social currency score for an item of media. In some embodiments, a social-currency-generation action may only increase the social currency score for an item of media. Additionally or alternatively, a social-currency-generation action may decrease the social currency score for an item of media.

Identification module 108 may identify the item of media in a variety of ways and/or contexts. For example, identification module 108 may identify an item of media as part of a search for eligible items of media to include in a media popularity chart. In some examples, identification module 108 may identify an eligible item of media when a social-currency-generation action generates social currency for the item of media.

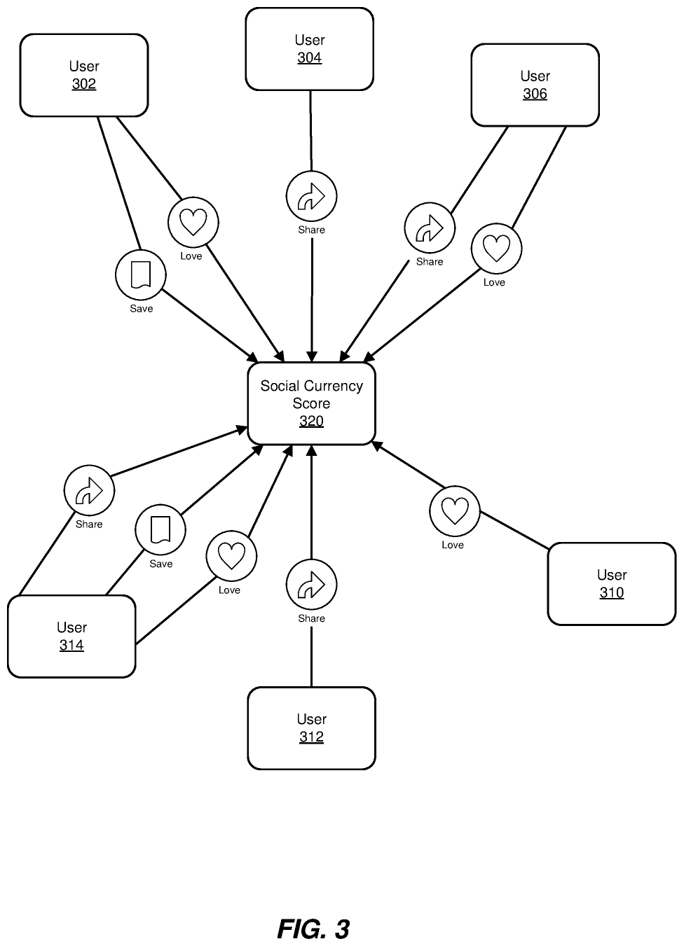

In some embodiments, multiple different users may perform social-currency-generation actions of different types on an item of media. For example, as illustrated in FIG. 3, users 302, 304, 30, 308, 310, and/or 312 may all perform social-currency-generation actions that may contribute to a social currency score 320 for an item of media. In one example, user 302 may love and save the item of media, generating a set amount of social currency for each action. In another example, user 314 may love, save, and share the item of media, generating even more social currency for the item of media than user 302. In some embodiments, different social-currency-generation actions may have different weights. For example, loving an item of media may generate less social currency than sharing the item of media because sharing the item of media may represent a greater degree of investment on the part of the user in the popularity of the item of media. Similarly, saving an item of media may generate more social currency than loving the item of media but less social currency than sharing the item of media. In one example, loving an item of media may generate one unit of social currency, saving the item of media may generate two units of social currency, and/or sharing the item of media may generate three units of social currency. In other examples, the systems described herein may assign other weights to loving, sharing, saving, and/or performing other actions on an item of media.

Returning to FIG. 2, at step 204, one or more of the systems described herein may track a social currency score for the item of media that increases whenever a user of the social networking platform performs a social-currency-generation action on the item of media. For example, tracking module 110 may, as part of server 102 in FIG. 1, track social currency score 114 for item of media 106 that increases whenever a user of social networking platform 104 performs a social-currency-generation action on item of media 106.

Tracking module 110 may track the social currency score in a variety of ways and/or contexts. For example, tracking module 110 may track social currency stores and store the tracked social currency scores in a database. In some embodiments, tracking module 110 may update the social currency score for an item of media every time a social-currency-generation action is performed on the item of media. Additionally or alternatively, tracking module 110 may update social currency scores at set intervals (e.g., once a minute, once an hour, or once a day). In some embodiments, tracking module 110 may assign a different weight to different types of social-currency-generation actions. In some examples, tracking module 110 may assign different weights to different types of actions performed via a sentiment widget. For example, expressing a “love” sentiment may generate more social currency than expressing a “like” sentiment. In some embodiments, tracking module 110 may not increase social currency scores in response to negative sentiments (e.g., “angry”) and/or may decrease social currency scores in response to negative sentiments.

At step 206, one or more of the systems described herein may define parameters for items of media to be included in a media popularity chart for the social networking platform. For example, chart module 112 may, as part of server 102 in FIG. 1, define parameters for items of media to be included in media popularity chart 116 for the social networking platform.

In some examples, the term “media popularity chart,” as used herein, may generally refer to any ordered listing of items of media. In some examples, a media popularity chart may only include items of media that fit certain parameters. For example, chart module 112 may define parameters that only include items of media of a certain type, such as songs, music videos, or videos. In another example, chart module 112 may define parameters that include items of media of a certain type and genre, such as country songs, songs from the '90s, or Bollywood songs.

At step 208, one or more of the systems described herein may rank the item of media in the media popularity chart in accordance with the social currency score for the item of media relative to social currency scores for other items of media and based on the item of media fitting the parameters for inclusion in the media popularity chart. For example, chart module 112 may, as part of server 102 in FIG. 1, rank item of media 106 in media popularity chart 116 in accordance with social currency score 114 for item of media 106 relative to social currency scores for other items of media and based on item of media 106 fitting the parameters for inclusion in media popularity chart 116.

Chart module 112 may rank items of media in a variety of ways and/or contexts. For example, chart module 112 may rank items of media based on social currency generated by any source at any time. In another example, chart module 112 may rank items of media based on social currency generated within a set window of time. For example, chart module 112 may rank items of media in a “popular music this week” chart, a “most popular music videos last year” chart, and/or a “popular videos today” chart.

Additionally or alternatively, chart module 112 may rank items based on social currency generated by a specific group of users. For example, chart module 112 may rank items based on social currency generated by a geographic group of users who live in the same city, state, region, or country. In another example, chart module 112 may rank items based on social currency generated by interest-based groups of users. For example, chart module 112 may generate customized popularity charts for songs, videos, and/or other media for user-created groups based around shared interests and hobbies, enabling members of the group to see what media is popular with other members of the group. In some embodiments, the systems described herein may generate media popularity charts for automatically generated groups of users, such as a group of users who all indicated that they attended the same college, a group of users that are all connected to one specific user, a group of users who marked themselves as attending a specific event, and/or any other relevant grouping of users.

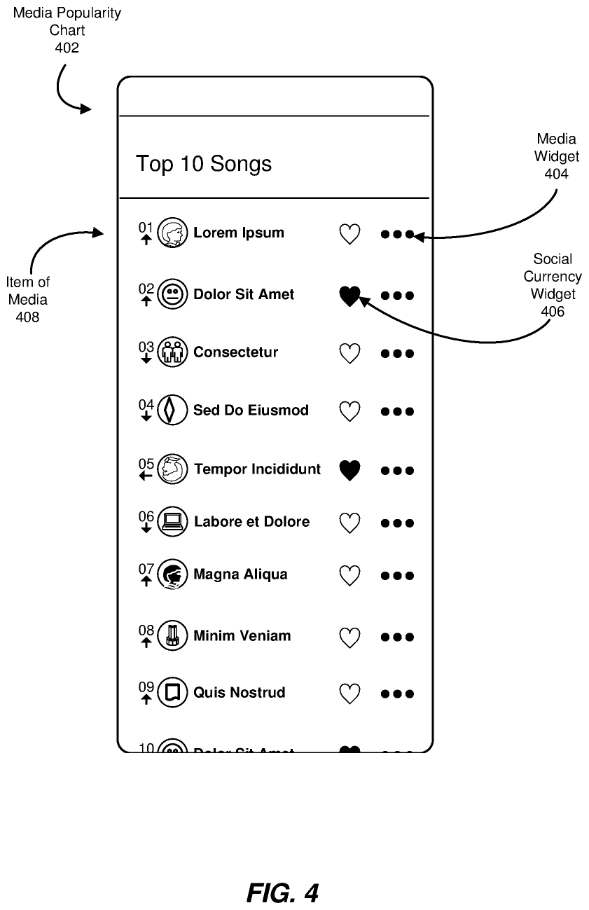

In some embodiments, the systems described herein may display a media popularity chart with one or more social currency widgets and/or media widgets. For example, as illustrated in FIG. 4, a media popularity chart 402 may include a listing for an item of media 408 that includes various information about the item of media (e.g., title, creator, album, etc.) as well as a social currency widget 406 and/or a media widget 404. In some embodiments, social currency widget 406 may enable the user to perform social-currency-generation actions, such as expressing a sentiment about the item of media, sharing the item of media, and/or saving the item of media. For example, social currency widget 406 may enable the user to like or love the item of media. In one embodiment, media popularity chart 402 may display which items of media within the chart the user has previously performed social-currency-generation actions on, such as liking or loving the item of media. By displaying information relevant to the user, the systems described herein may encourage the user to explore new media (e.g., by making it clearer which items of media the user has not previously interacted with) and/or increase user engagement with the popularity chart (e.g., by showing the user that items they have interacted with made it into the chart).

In some embodiments, the systems described herein may generate social-currency-based popularity charts for media creators. For example, the systems described herein may aggregate the social currency scores of all items of media produced by a media creator to create a social media score for the media creator. In one embodiment, the systems described herein may generate a media creator popularity chart for creators of a certain type of media (e.g., music videos, songs, etc.), creators of media within a certain genre, and/or any other subset of media creators and/or types of item of media. In some embodiments, the systems described herein may create group-specific media creator popularity charts, such as “top musicians listened to by corgi lovers in 2019” or “top 10 artists in Mumbai.”

In some embodiments, media widget 404 may enable the user to view a media interface page for the item of media. In one embodiment, interacting with media widget 404 (e.g., clicking, tapping, etc.) may take the user from the popularity chart to the media interface page. In another embodiment, interacting with media widget 404 may bring up the media interface page as an overlay over the popularity chart that may be dismissed to return the user to the media popularity chart. In some embodiments, a social networking platform may display a media widget on various different instances of an item of media that may enable the user to view the same media interface page regardless of which instance of the item of media the user interacted with. For example, the systems described herein may display the media widget on, within, and/or next to a reference to the item of media in a media popularity chart, a shared version of the media, a different item of media within which the media is embedded (e.g., a video featuring a song), a link to an instance of the item of media hosted on a different platform, a user post or story that includes the item of media, an event listing that includes a reference to the item of media (e.g., a concert at which a song is played), and/or any other appropriate instance of and/or reference to the item of media.

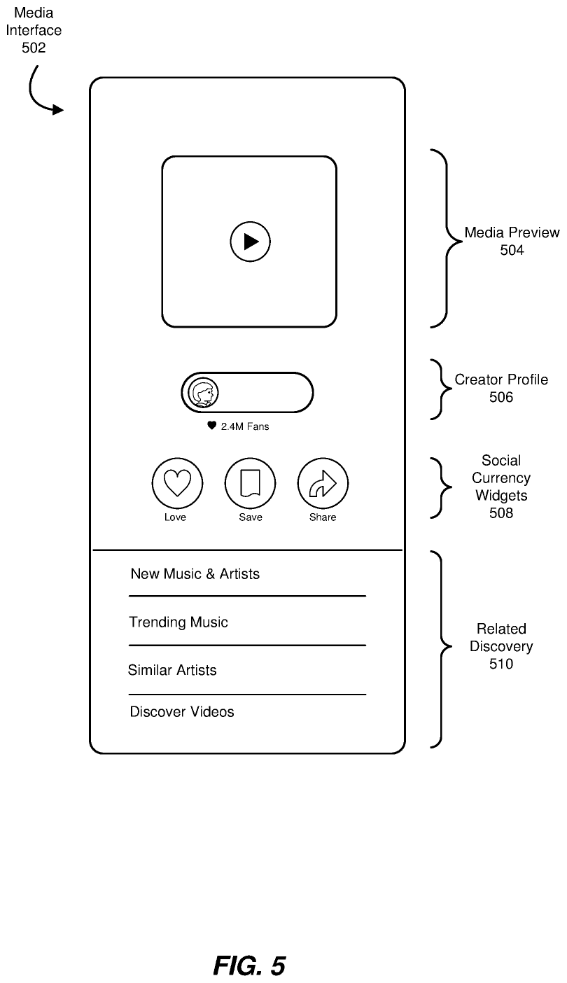

In some embodiments, a media interface page for an item of media may include various types of information about and/or ways to interact with the item of media. For example, as illustrated in FIG. 5, a media interface 502 may include a media preview 504 that may enable a user to view and/or listen to some or all of the item of media, a creator profile 506 that may include information about one or more creators of the item of media and/or a link to a creator profile page, social currency widgets 508 that may enable the user to perform various social-currency-generation actions on the item of media, and/or related discovery 510 that may enable the user to discover items of media that are related to the item of media. In some embodiments, related discovery 510 may enable a user to discover additional instances of the item of media on the social networking platform, such as videos that feature the item of media, posts that include the item of media, and/or popularity charts that include the item of media. In one embodiment, media interface 502 may display the same type of information in the same format regardless of the location from which a user accesses media interface 502. For example, the systems described herein may display media interface 502 to a user interacting with a media widget on a media popularity chart, a link to an instance of the item of media on another platform, and/or an instance of the item of media embedded in another item of media. In some embodiments, media interface 502 may enable a user to stream media in the background while interacting with other facets of a social networking platform application and/or other applications.

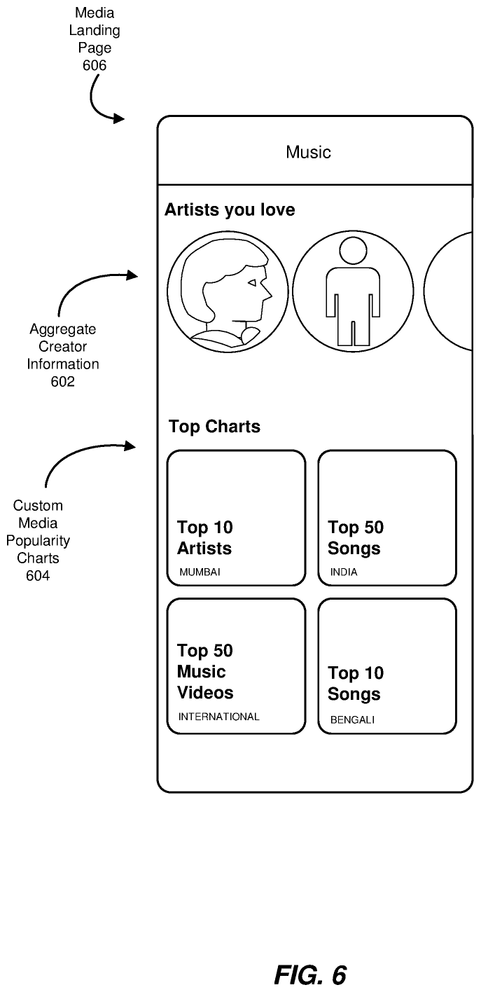

In some embodiments, the systems described herein may display a personalized media landing page for a user based at least in part on social-currency-generation actions performed by the user and/or other information about the user. In one embodiment, as illustrated in FIG. 6, a media landing page 606 may include aggregate creator information 602 about media creators who have created items of media for which the user has generated social currency. Additionally or alternatively, a media landing page 606 may include custom media popularity charts 604. In one example, custom media popularity charts 604 may include socially-currency-score-based charts for groups to which the user belongs (e.g., geographic groups, interest-based groups, etc.) for items of media of various types and/or media creators.

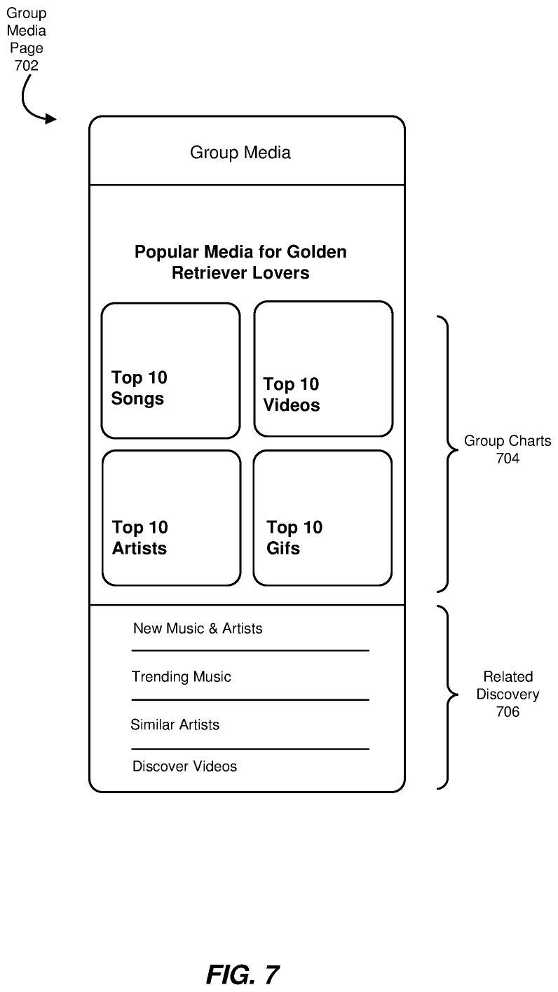

In some embodiments, the systems described herein may display a page in a group interface that includes social-currency-based popularity charts for media based on social currency generated by members of the group. For example, as illustrated in FIG. 7, a group media page 702 may include group charts 704 and/or related discovery 706. In some embodiments, popularity charts for various types and/or categories of media may be embedded directly into group media page 702 (e.g., in a form resembling media popularity chart 402 in FIG. 4). Additionally or alternatively, group media page 702 may include links to multiple individual media popularity charts. In some embodiments, group charts 704 may be automatically generated by the social networking platform by calculating group-specific social media scores by aggregating social-currency-generation actions performed on items of media by members of the group while excluding social-currency-generation actions performed by users who are not members of the group and then ranking items of media in accordance with the group-specific social media scores.

In one embodiment, the social networking platform may also generate related discovery 706 that includes references to items of media that are related to the items of media included in the group media popularity chart. In some examples, related discovery 706 may enable users to discover relevant groups by including references to additional groups in which media in group charts 704 is also popular. For example, a user in a “Golden Retriever Lovers” group may discover a “Samoyed Lovers” group after viewing the group media page for the “Golden Retriever Lovers” group and seeing a reference to the “Samoyed Lovers” group that is included in related discovery 706 based on the “Samoyed Lovers” group having similar taste in videos.

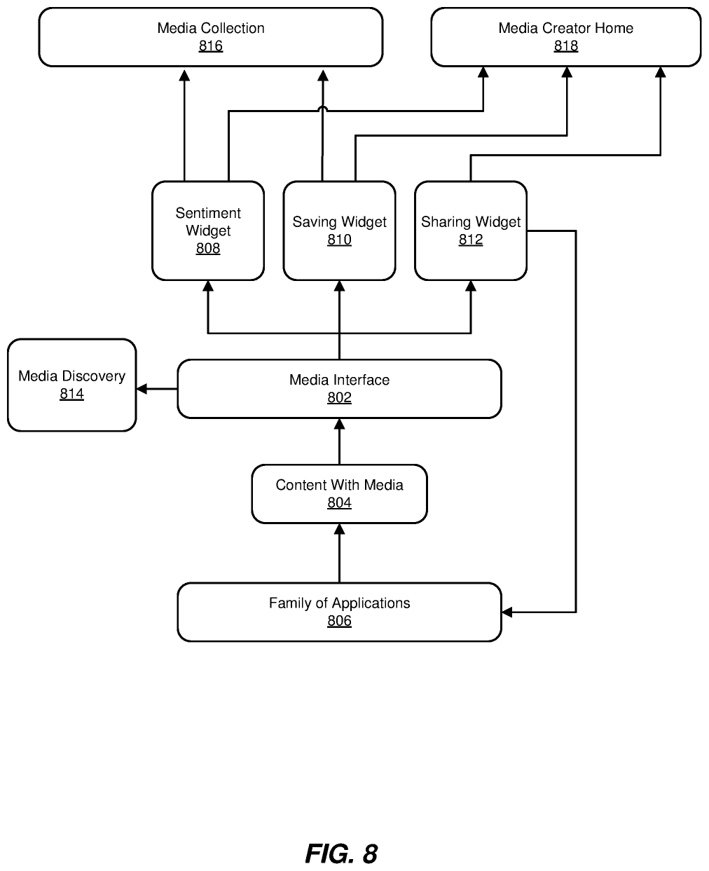

In some embodiments, the systems described herein may track social currency scores across a family of applications. For example, as illustrated in FIG. 8, a family of applications 806 may host various content with media 804 that may all enable a user to access a media interface 802. In one example, family of applications 806 may include a social networking platform application, a messaging application associated with the social networking platform, a media consumption application associated with the social networking platform, and/or other similar applications. In some embodiments, media interface 802 may include media discovery 814, a sentiment widget 808, a saving widget 810, and/or a sharing widget 812. In one embodiment, when a user performs actions on an item of media via sentiment widget 808 and/or saving widget 810, the systems described herein may add the item of media to a media collection 816 for the user. In some embodiments, media collection 816 may enable a user to consume media, sort media, label media, and/or perform other actions on items of media. In some examples, when a user performs an action on an item of media via sentiment widget 808, saving widget 810, and/or sharing widget 812, statistics about the action may be displayed in a media creator home 818. In some embodiments, media creator home 818 may include a dashboard that enables a creator of media to view social currency scores for items of media created by the media creator. In one embodiment, media creator home 818 may display detailed information about shares, sentiment, saves, and/or other social-currency-generation actions performed on items of media. In some embodiments, media creator home 818 may display social currency information divided by application, granting a media creator insight into the popularity of various items of media across different platforms.

As described above, the systems and methods described herein may track social currency scores for items of media based on social-currency-generation actions performed by users of a social networking platform. In some embodiments, the systems described herein may create media popularity charts by ranking items of media in accordance with social currency scores generated by users of the social networking platform as a whole and/or users of specific groups. In one embodiment, a family of social networking applications may include a media widget that enables a user to access a unified media interface regardless of where an item of media is discovered. In some examples, social-currency-based media popularity charts and/or a unified media interface across a family of social networking applications may enable users to discover media through social relationships, build and maintain a media identity, centralize their media collection, and/or affect the popularity of media creators.

### Example Embodiments

Example 1: A computer-implemented method may include (i) identifying an item of media hosted on a social networking platform that tracks social currency scores for media, (ii) tracking a social currency score for the item of media that increases whenever a user of the social networking platform performs a social-currency-generation action on the item of media, (iii) defining parameters for items of media to be included in a media popularity chart for the social networking platform, and (iv) ranking the item of media in the media popularity chart in accordance with the social currency score for the item of media relative to social currency scores for other items of media and based on the item of media fitting the parameters for inclusion in the media popularity chart.

Example 2: The computer-implemented method of Example, where tracking the social currency score for the item of media includes tracking a set of social-currency-generation actions of different types and calculating the social currency score for the item of media based on a quantity of social-currency-generation actions of each type performed on the item of media and a weight assigned to each type of social-currency-generation action.

Example 3: The computer-implemented method of examples 1 and 2, where the social-currency-generation action includes at least one of (i) the user expressing positive sentiment about the item of media via a sentiment widget, (ii) the user sharing the item of media with additional users, or (iii) the user saving the item of media to a collection of saved media.

Example 4: The computer-implemented method of examples 1-3, further including displaying a dashboard that enables a creator of the item of media to view at least one statistic about social-currency-generation actions performed on the item of media.

Example 5: The computer-implemented method of examples 1-4, where ranking the item of media in the media popularity chart in accordance with the social currency score for the item of media relative to the social currency scores for other items of media includes (i) identifying a group of users of the social networking platform, (ii) calculating a group-specific social currency score for the item of media that includes social-currency-generation actions performed by members of the group of users and excludes social-currency-generation actions performed by users who are not members of the group of users, and (iii) ranking the item of media in the media popularity chart in accordance with the group-specific social currency score relative to group-specific social currency scores for the other items of media.

Example 6: The computer-implemented method of examples 1-5, where the group of users includes an interest-based group on the social networking platform.

Example 7: The computer-implemented method of examples 1-6, further including displaying the media popularity chart on a user interface page associated with the group.

Example 8: The computer-implemented method of examples 1-7, further including displaying the media popularity chart on the social networking platform and displaying the item of media within the media popularity chart on the social networking platform using a media widget that enables the user to view an interface page for the item of media.

Example 9: The computer-implemented method of examples 1-8, where the media widget enables the user to view the interface page for the item of media when the media widget is accessed from at least one of a media popularity chart interface that includes the item of media, a personal user page that includes the item of media, a public page that includes the item of media, an additional item of media in which the item of media is embedded, or a private message that includes the item of media.

Example 10: The computer-implemented method of examples 1-9, where the interface page for the item of media includes at least one of a media player that enables the user to play the item of media, a sentiment widget that enables the user to express a sentiment about the item of media, a sharing widget that enables the user to share the item of media, and information about the item of media.

Example 11: The computer-implemented method of examples 1-10, further including ranking media creators in a media creator popularity chart in accordance with the aggregate social currency scores for items of media created by the media creators.

Example 12: A system for generating social-currency based charts may include at least one physical processor and physical memory comprising computer-executable instructions that, when executed by the physical processor, cause the physical processor to (i) identify an item of media hosted on a social networking platform that tracks social currency scores for media, (ii) track a social currency score for the item of media that increases whenever a user of the social networking platform performs a social-currency-generation action on the item of media, (iii) define parameters for items of media to be included in a media popularity chart for the social networking platform, and (iv) rank the item of media in the media popularity chart in accordance with the social currency score for the item of media relative to social currency scores for other items of media and based on the item of media fitting the parameters for inclusion in the media popularity chart.

Example 13: The system of example 12, where the tracking the social currency score for the item of media includes tracking a set of social-currency-generation actions of different types and calculating the social currency score for the item of media based on a quantity of social-currency-generation actions of each type performed on the item of media and a weight assigned to each type of social-currency-generation action.

Example 14: The system of examples 12 and 13, where the social-currency-generation action includes at least one of the user expressing positive sentiment about the item of media via a sentiment widget, the user sharing the item of media with additional users, or the user saving the item of media to a collection of saved media.

Example 15: The system of examples 12-14, where the computer-executable instructions further cause the physical processor to display a dashboard that enables a creator of the item of media to view at least one statistic about social-currency-generation actions performed on the item of media.

Example 16: The system of examples 12-15, where ranking the item of media in the media popularity chart in accordance with the social currency score for the item of media relative to the social currency scores for other items of media includes (i) identifying a group of users of the social networking platform, (ii) calculating a group-specific social currency score for the item of media that includes social-currency-generation actions performed by members of the group of users and excludes social-currency-generation actions performed by users who are not members of the group of users, and (iii) ranking the item of media in the media popularity chart in accordance with the group-specific social currency score relative to group-specific social currency scores for the other items of media.

Example 17: The system of examples 12-16, where the group of users includes an interest-based group on the social networking platform.

Example 18: The system of examples 12-17, where the computer-executable instructions further cause the physical processor to display the media popularity chart on a user interface page associated with the group.

Example 19: The system of Examples 12-18, where the computer-executable instructions further cause the physical processor to display the media popularity chart on the social networking platform and display the item of media within the media popularity chart on the social networking platform using a media widget that enables the user to view an interface page for the item of media.

Example 20: A non-transitory computer-readable medium including one or more computer-readable instructions that, when executed by at least one processor of a computing device, cause the computing device to (i) identify an item of media hosted on a social networking platform that tracks social currency scores for media, (ii) track a social currency score for the item of media that increases whenever a user of the social networking platform performs a social-currency-generation action on the item of media, (iii) define parameters for items of media to be included in a media popularity chart for the social networking platform, and (iv) rank the item of media in the media popularity chart in accordance with the social currency score for the item of media relative to social currency scores for other items of media and based on the item of media fitting the parameters for inclusion in the media popularity chart.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive image data to be transformed, transform the image data into a data structure that stores user characteristic data, output a result of the transformation to select a customized interactive ice breaker widget relevant to the user, use the result of the transformation to present the widget to the user, and store the result of the transformation to create a record of the presented widget. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

1. A computer-implemented method comprising:
identifying an item of media hosted on a social networking platform that tracks social currency scores for media;
tracking a social currency score for the item of media that increases whenever users of the social networking platform perform a social-currency-generation action on the item of media;
defining parameters for items of media to be included in a media popularity chart for the social networking platform;
ranking the item of media in accordance with the social currency score for the item of media relative to social currency scores for other items of media and based on the item of media fitting the parameters for inclusion in the media popularity chart;
generating, based on both the parameters for items of media to be included in the media popularity chart and the ranking of the item of media relative to other items of media, the media popularity chart;
displaying, to a user of the social networking platform, the media popularity chart in conjunction with one or more social currency widgets that enable the user to perform social-currency generating actions on items of media displayed as part of the media popularity chart; and
displaying, to the user of the social networking platform in conjunction with the one or more social currency widgets and in conjunction with the media popularity chart, a related discovery comprising references to additional instances on the social networking platform of at least one item of media that is included in the media popularity chart.

2. The computer-implemented method of claim 1, wherein tracking the social currency score for the item of media comprises:
tracking a set of social-currency-generation actions of different types; and
calculating the social currency score for the item of media based on a quantity of social-currency-generation actions of each type performed on the item of media and a weight assigned to each type of social-currency-generation action.

3. The computer-implemented method of claim 1, wherein the social-currency-generation action comprises at least one of:
the user expressing positive sentiment about the item of media via a sentiment widget;
the user sharing the item of media with additional users; or
the user saving the item of media to a collection of saved media.

4. The computer-implemented method of claim 1, further comprising displaying a dashboard that enables a creator of the item of media to view at least one statistic about social-currency-generation actions performed on the item of media.

5. The computer-implemented method of claim 1, wherein ranking the item of media in the media popularity chart in accordance with the social currency score for the item of media relative to the social currency scores for other items of media comprises:
identifying a group of users of the social networking platform;
calculating a group-specific social currency score for the item of media that includes social-currency-generation actions performed by members of the group of users and excludes social-currency-generation actions performed by users who are not members of the group of users; and
ranking the item of media in the media popularity chart in accordance with the group-specific social currency score relative to group-specific social currency scores for the other items of media.

6. The computer-implemented method of claim 5, wherein the group of users comprises an interest-based group on the social networking platform.

7. The computer-implemented method of claim 5, further comprising displaying the media popularity chart on a user interface page associated with the group.

8. The computer-implemented method of claim 1, further comprising:
displaying the media popularity chart on the social networking platform; and
displaying the item of media within the media popularity chart on the social networking platform using a media widget that enables the user to view an interface page for the item of media.

9. The computer-implemented method of claim 8, wherein the media widget enables the user to view the interface page for the item of media when the media widget is accessed from at least one of:
a media popularity chart interface that comprises the item of media;
a personal user page that comprises the item of media;
a public page that comprises the item of media;
an additional item of media in which the item of media is embedded; or
a private message that comprises the item of media.

10. The computer-implemented method of claim 8, wherein the interface page for the item of media comprises at least one of:
a media player that enables the user to play the item of media;
a sentiment widget that enables the user to express a sentiment about the item of media;
a sharing widget that enables the user to share the item of media; and
information about the item of media.

11. The computer-implemented method of claim 10, further comprising ranking media creators in a media creator popularity chart in accordance with aggregate social currency scores for items of media created by the media creators.

12. A system comprising:
at least one physical processor;
physical memory comprising computer-executable instructions that, when executed by the physical processor, cause the physical processor to:
identify an item of media hosted on a social networking platform that tracks social currency scores for media;
track a social currency score for the item of media that increases whenever users of the social networking platform perform a social-currency-generation action on the item of media;
define parameters for items of media to be included in a media popularity chart for the social networking platform;
rank the item of media in accordance with the social currency score for the item of media relative to social currency scores for other items of media and based on the item of media fitting the parameters for inclusion in the media popularity chart;
generate, based on both the parameters for items of media to be included in the media popularity chart and the ranking of the item of media relative to other items of media, the media popularity chart;
display, to a user of the social networking platform, the media popularity chart in conjunction with one or more social currency widgets that enable the user to perform social-currency generating actions on items of media displayed as part of the media popularity chart; and
display, to the user of the social networking platform in conjunction with the one or more social currency widgets and in conjunction with the media popularity chart, a related discovery comprising references to additional instances on the social networking platform of at least one item of media that is included in the media popularity chart.

13. The system of claim 12, wherein the tracking the social currency score for the item of media comprises:
tracking a set of social-currency-generation actions of different types; and
calculating the social currency score for the item of media based on a quantity of social-currency-generation actions of each type performed on the item of media and a weight assigned to each type of social-currency-generation action.

14. The system of claim 12, wherein the social-currency-generation action comprises at least one of:
a user expressing positive sentiment about the item of media via a sentiment widget;
the user sharing the item of media with additional users; or
the user saving the item of media to a collection of saved media.

15. The system of claim 12, wherein the computer-executable instructions further cause the physical processor to display a dashboard that enables a creator of the item of media to view at least one statistic about social-currency-generation actions performed on the item of media.

16. The system of claim 12, wherein ranking the item of media in the media popularity chart in accordance with the social currency score for the item of media relative to the social currency scores for other items of media comprises:
identifying a group of users of the social networking platform;
calculating a group-specific social currency score for the item of media that includes social-currency-generation actions performed by members of the group of users and excludes social-currency-generation actions performed by users who are not members of the group of users; and
ranking the item of media in the media popularity chart in accordance with the group-specific social currency score relative to group-specific social currency scores for the other items of media.

17. The system of claim 16, wherein the group of users comprises an interest-based group on the social networking platform.

18. The system of claim 16, wherein the computer-executable instructions further cause the physical processor to display the media popularity chart on a user interface page associated with the group.

19. The system of claim 12, the computer-executable instructions further cause the physical processor to:
display the media popularity chart on the social networking platform; and
display the item of media within the media popularity chart on the social networking platform using a media widget that enables the user to view an interface page for the item of media.

20. A non-transitory computer-readable medium comprising one or more computer-readable instructions that, when executed by at least one processor of a computing device, cause the computing device to:
identify an item of media hosted on a social networking platform that tracks social currency scores for media;
track a social currency score for the item of media that increases whenever users of the social networking platform perform a social-currency-generation action on the item of media;
define parameters for items of media to be included in a media popularity chart for the social networking platform;
rank the item of media in accordance with the social currency score for the item of media relative to social currency scores for other items of media and based on the item of media fitting the parameters for inclusion in the media popularity chart;
generate, based on both the parameters for items of media to be included in the media popularity chart and the ranking of the item of media relative to other items of media, the media popularity chart;
display, to a user of the social networking platform, the media popularity chart in conjunction with one or more social currency widgets that enable the user to perform social-currency generating actions on items of media displayed as part of the media popularity chart; and
display, to the user of the social networking platform in conjunction with the one or more social currency widgets and in conjunction with the media popularity chart, a related discovery comprising references to additional instances on the social networking platform of at least one item of media that is included in the media popularity chart.
